(19) United States
(12) Patent Application Publication
(10) Pub. No.: US 2018/0311902 A1
(43) Pub. Date: Nov. 1, 2018

(54) COLOR THREE-DIMENSIONAL PRINTING METHOD AND THREE-DIMENSIONAL PRINTING EQUIPMENT

(71) Applicants: XYZprinting, Inc., New Taipei City (TW); Kinpo Electronics, Inc., New Taipei City (TW)

(72) Inventors: Kwan Ho, New Taipei City (TW); Yu-Ting Huang, New Taipei City (TW); Hsin-Ta Hsieh, New Taipei City (TW)

(73) Assignees: XYZprinting, Inc., New Taipei City (TW); Kinpo Electronics, Inc., New Taipei City (TW)

(21) Appl. No.: 15/857,631

(22) Filed: Dec. 29, 2017

(30) Foreign Application Priority Data
Apr. 28, 2017 (TW) 106114349

(51) Int. Cl. B29C 64/393; B29C 64/112; G05B 19/4099

(52) U.S. Cl. CPC B29C 64/393; B33Y 10/00; G05B 19/4099; B29C 64/112

(57) ABSTRACT

A color three-dimensional printing method and a three-dimensional printing equipment are provided. A slicing processing is performed on a 3D model to obtain a printing path file and a plurality of inkjet images. A first layer controlling data in the printing path file is read, wherein the first layer controlling data records a plurality of printing position points and a plurality of inkjet position points. Movement of a printing head is controlled according to the printing position points, and the printing head is controlled to extrude a forming material, to establish a first layer object. A first inkjet image among the inkjet images is read. Movement of an inkjet head on a plane is controlled according to the inkjet position points, and the inkjet head is controlled to spray the ink on the first layer object according to the first inkjet image.

### CROSS-REFERENCE TO RELATED APPLICATION

This application claims the priority benefit of Taiwan application serial no. 106114349, filed on Apr. 28, 2017. The entirety of the above-mentioned patent application is hereby incorporated by reference herein and made a part of this specification.

### BACKGROUND

### Technical Field

The disclosure relates to a printing method and particularly relates to a color three-dimensional printing method and a three-dimensional printing equipment.

### Description of Related Art

With the progress of computer-aided manufacturing (CAM), the manufacturing industry has developed three-dimensional printing technology able to rapidly manufacture an original concept of a design. The 3D printing technology is actually a general term of a series of rapid prototyping (RP) technologies. Their basic principles are all related to lamination manufacturing. A rapid prototyping machine forms a cross section shape of a workpiece by scanning in an X-Y plane, and intermittently displaces in thickness of a layer in a Z-coordinate, and forms a 3D object finally. The 3D printing technology does not limit a geometric shape, and even, a more complex part is manufactured, more prominence of RP technology is shown. Further, manpower and processing time can be greatly reduced. Within the minimum time limit, a digital 3D model designed by a computer-aided design (CAD) software can be realized.

For example, fused deposition modeling (FDM) technology turns a forming material into a wire, and heats and melts the forming material to stack the material layer by layer on a forming stage according to the desired shape/contour to form a 3D object. Thus, in the conventional color FDM 3D printing method, the exterior is usually colored after the three-dimensional object is completed, or the three-dimensional object is manufactured by using a colored forming material. In the former case, however, the color ink is only applied to the outer surface of the three-dimensional object, which may be slightly inferior in color properties and variability. In the latter case, it will be required to repeatedly switch to wire materials of different colors in order to achieve the effect of multiple colors, as a result, the efficiency of manufacturing a colored three-dimensional object is low. Accordingly, how to improve the above situation is an issue to be considered by people in the related art.

### SUMMARY

In this regard, the disclosure provides a color three-dimensional printing method and a three-dimensional printing equipment, able to improve the diversity and aesthetics of color 3D printing.

The disclosure provides a color three-dimensional printing method adapted for manufacturing a 3D object according to a 3D model. The 3D object includes a plurality of layer objects. The method includes following steps. A slicing processing is performed on the 3D model to obtain a printing path file and a plurality of inkjet images, wherein the printing path file includes a plurality of layer controlling data respectively corresponding to the layer objects. A first layer controlling data among the layer controlling data is read, wherein the first layer controlling data records a plurality of printing position points and a plurality of inkjet position points. Movement of a printing head is controlled according to the printing position points and the printing head is controlled to extrude a forming material to establish a first layer object among the layer objects. A first inkjet image among the inkjet images is read. Movement of an inkjet head on a plane is controlled according to the inkjet position points, and the inkjet head is controlled to spray ink on the first layer object according to the first inkjet image.

From another point of view, the disclosure provides a three-dimensional printing equipment including a storage device, a processor and a 3D printing device. The processor is coupled to the storage device and configured to: perform a slicing processing on the 3D model to obtain a printing path file and a plurality of inkjet images, wherein the printing path file comprises a plurality of layer controlling data respectively corresponding to a plurality of layer objects. The 3D printing device is connected to the processor and includes a printing mechanism, an inkjet mechanism and a controller. The printing mechanism includes a printing head and the inkjet mechanism includes an inkjet head. The controller is coupled to the printing mechanism and the inkjet mechanism and configured to: read a first layer controlling data among the layer controlling data, wherein the first layer controlling data includes a plurality of printing position points and a plurality of inkjet position points; control movement of a printing head according to the printing position points and control the printing head to extrude a forming material to establish a first layer object among the layer objects; read a first inkjet image among the inkjet images; and control movement of an inkjet head on a plane according to the inkjet position points and control the inkjet head to spray ink on the first layer object according to the first inkjet image.

Based on the above, the color three-dimensional printing method and the three-dimensional printing equipment of the disclosure may use the printing head to form a layer object on a stage and then use the inkjet head to spray ink on the layer object to form an ink layer. Such that, the layer object of each layer of the colored 3D object has a colored appearance so that the overall color property is improved. Also, different regions of each color ink layer may have different colors so that color variability is improved.

To make the aforementioned and other features and advantages of the disclosure more comprehensible, several embodiments accompanied with drawings are described in detail as follows.

### BRIEF DESCRIPTION OF THE DRAWINGS

FIG. 1 is a schematic view of a three-dimensional printing equipment according to an exemplary embodiment of the disclosure.

FIG. 2 is a schematic view of a 3D printing device according to an exemplary embodiment of the disclosure.

FIG. 3 is a flowchart of a color 3D printing method according to an exemplary embodiment of the disclosure.

FIG. 4 is a schematic view of a color 3D printing method according to an exemplary embodiment of the disclosure.

FIG. 5 is a flowchart of adjusting an inkjet position on a horizontal plane according to an exemplary embodiment of the disclosure.

FIG. 6 is a schematic view of adjusting an inkjet position on a horizontal plane according to an exemplary embodiment of the disclosure.

### DESCRIPTION OF EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts. Indeed, various embodiments of the disclosure may be embodied in many different forms and should not be construed as limited to the embodiments set forth herein; rather, these embodiments are provided so that this disclosure will satisfy applicable legal requirements.

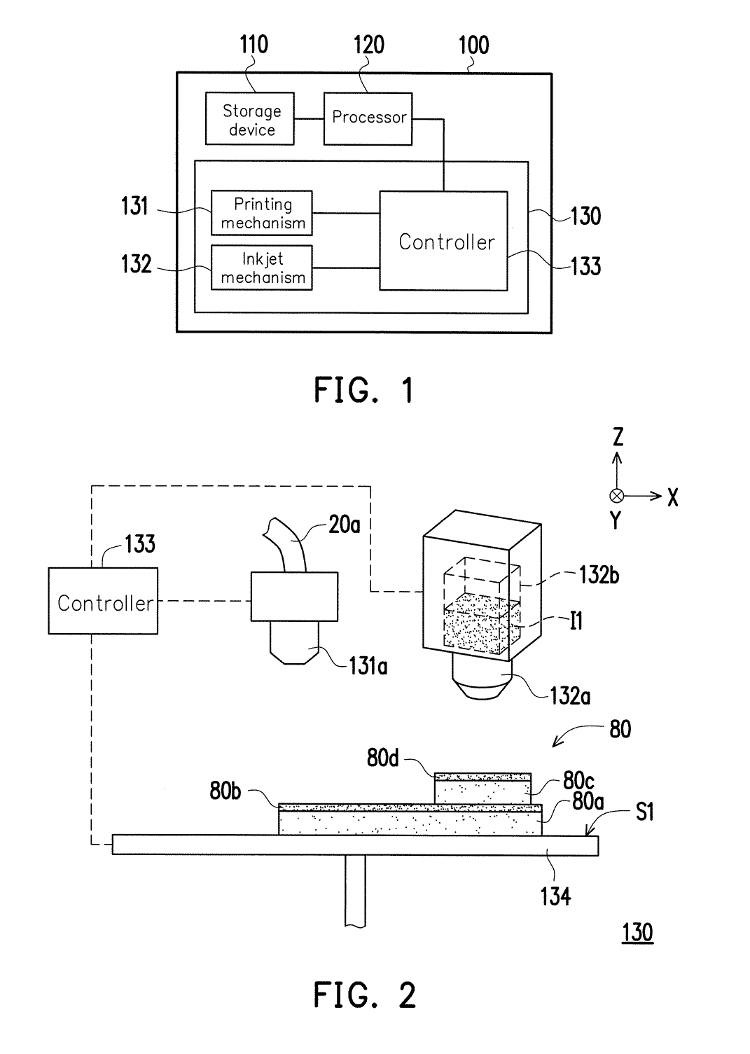

FIG. 1 is a schematic view of a three-dimensional printing equipment according to an exemplary embodiment. Referring to FIG. 1, a 3D printing equipment 100 includes a storage device 110, a processor 120 and a 3D printing device 130. The processor 120 is coupled to the storage device 110 and the 3D printing device 130. In this embodiment, the processor 120 is configured to model a 3D object to establish a 3D model, wherein the 3D model conforms to a 3D file format such as a polygon file format (PLY) or an OBJ file. The 3D model in the 3D file format is composed of a plurality of polygon meshes and each of the polygon meshes has a plurality of vertices, wherein each of these vertices has a different coordinate. In this embodiment, the processor 120 may be configured to perform a slicing processing on the 3D model in a 3D model image to obtain slicing information. The slicing information includes a printing path file and a plurality of inkjet images. According to the slicing information, the processor 120 controls the 3D printing device 130 to perform a 3D printing operation so that the 3D printing device 130 manufactures a plurality of layer objects layer by layer and colors these layer objects layer by layer.

In this embodiment, the storage device 110 may be configured to store data and be a buffer memory, an internal storage medium, an external storage medium, other types of storage devices or a combination of these devices. For instance, the buffer memory may include a random access memory, a read only memory or other similar devices. For instance, the internal storage medium may include a hard disk drive (HDD), a solid state disk, a flash storage device or other similar devices. For instance, the external storage medium may include an external hard drive, a USB drive, a cloud drive, or other similar devices. In this embodiment, the storage device 110 may be used to store the 3D model image, a plurality of slicing images, a 3D image modeling module, an image processing module or an image analysis module, etc., so as to realize the slicing image processing of each of the exemplary embodiments of the disclosure.

In this embodiment, the processor 120 may be configured to execute a plurality of modules stored in the storage device 110 so as to realize the image processing and image analysis of each of the exemplary embodiments of the disclosure. The processor 120 may be a central processing unit (CPU), or other programmable general/specific purpose microprocessors, a digital signal processor (DSP), a programmable controller, application specific integrated circuits (ASIC), a programmable logic device (PLD), other similar processing device or a combination of these devices.

In this embodiment, the 3D printing device 130 may include, for example, a controller 133, a printing mechanism 131 and an inkjet mechanism 132. The processor 120 may provide, according to the slicing information, a control signal to the controller 133 of the 3D printing device 130 to drive the 3D printing device 130. The controller 133 of the 3D printing device 130 may control the printing mechanism 131 and the inkjet mechanism 132 to perform the 3D printing operation and an inkjet operation. For example, the 3D printing operation includes feeding out a forming material and the 3D printing device 130 may perform the inkjet operation on the cured forming material. Further, people having ordinary skills in the art shall understand that the three-dimensional printing device 130 may also include other components required to perform three-dimensional printing together with a printing head (such as a stage, a feeding line, an inkjet line, a printing head linking mechanism, and the like).

Further, FIG. 2 is a schematic view of a 3D printing device illustrated according to an exemplary embodiment of the disclosure. Referring to FIG. 2, the 3D printing device 130 includes a stage 134, a printing head 131a, an inkjet head 132a and the controller 133. Here, a Cartesian coordinate system is provided on the drawing so as to describe relevant components and their movement. The stage 134 includes a carrying surface S1 for carrying a 3D object 80 in printing, and the stage 134 is provided below the printing head 131a and the inkjet head 132a.

In detail, in this embodiment, the printing head 131a is disposed to move along a XY plane and a normal direction (Z-axis direction) of the XY plane. A forming material 20a is fed into the printing head 131a via a feeding line to be thermally melted, and is extruded through the printing head 131a to be molded layer by layer on the carrying surface S1 of the stage 134 such that a plurality of layer objects (FIG. 2 takes layer objects 80a and 80c as examples) are formed. In this sense, the layer objects 80a and 80c formed layer by layer stack each other on the carrying surface S1 to formed a 3D object 80. Specifically, the forming material 20a may be composed of a thermofusible material adapted to a manufacturing method such as a fused filament fabrication (FFF) and a melted and extrusion modeling, which the exemplary examples are not intended to limit.

In this embodiment, the inkjet head 132a sprays ink I1 layer by layer on each of the layer objects to form a plurality of ink layers (FIG. 2 takes ink layers 80b and 80d as examples). Forming the ink layers 80b and 80d on the layer objects 80a and 80c refers to overlapping and covering the upper surfaces of the layer objects 80a and 80c by ink I1 and simultaneously dyeing the interior of the layer objects 80a and 80c. Therefore, the inkjet head 132a may include an ink cartridge 132b. The ink cartridge 132b is configured for holding the ink I1. The inkjet head 132a sprays the ink I1 in the ink cartridge 142 on the layer objects 80a and 80c as needed to color the layer objects 80a and 80c. Thereby, the ink layers 80b and 80d are formed on the layer objects 80a and 80c. Although FIG. 2 merely illustrates one ink cartridge 132b, the exemplary examples are not intended to limit an amount of the ink cartridge and ink color. In an embodiment, the inkjet head 132a is similar to a color inkjet system for a two-dimensional color printing device able to spray a plurality of color ink corresponding to different colors on the layer objects 80a and 80c according to a ratio of color formation, to form the ink layers 80b and 80d. The colors of the color ink include cyan, magenta, yellow and black in accordance with printing primary colors, which are not limited in the disclosure. It should be stated that in an embodiment, the forming material 20a may be a light-transmittable material, for example, a transparent polylactic acid (PLA) material or a transparent acrylic material. Since the forming material 20a has light-transmittance, the color performance of each ink layers may be seen as the color performance of the corresponding layer object.

With such arrangement, in this embodiment, after the printing head 131a prints the layer object 80a upon the stage 134, the inkjet head 132a may spray the ink layer 80b on the upper surface of the layer object 80a so as to color the layer object 80a. Then, after the printing head 110 prints another layer object 80c upon the stage 134, the inkjet head 132a may spray the ink layer 80d on the upper surface of the layer object 80c so as to color the layer object 80c. Such that, the layer objects 80a and 80c sequentially stack across the ink layers 80b and 80d so that a color 3D object 80 is formed, wherein the inkjet range and pattern of each ink layer are determined by a plurality of inkjet images in the slicing information.

The controller 133 coupled to the stage 134, the printing head 131a and the inkjet head 132a may be used to receive the slicing information provided by the processor 120 and to control the overall operation of the 3D printing device 130 according to the slicing information so that the 3D object 80 is printed out. For instance, according to a printing path file, the controller 133 controls a movement path of the printing head 131a according to the printing path file, and the printing path file is, for example, a control code file such as a G-code. The controller 133 is, for example, an equipment having a computing function such as a CPU, a chipset, a microprocessor, an embedded controller and the like, the disclosure provides no limitation thereto.

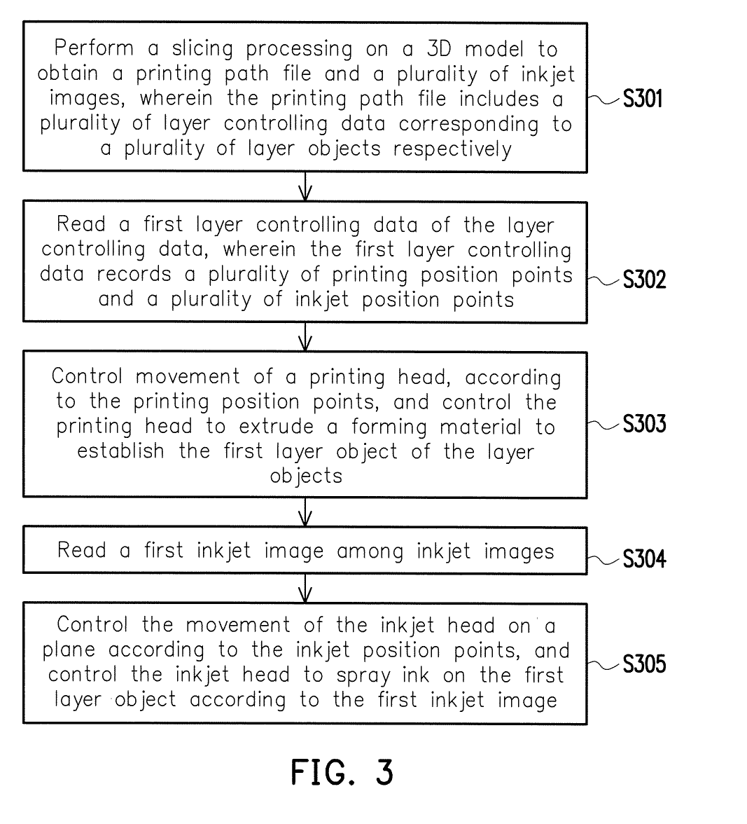

FIG. 3 is a flowchart of a color 3D printing method according to an embodiment of the disclosure. The method of this embodiment may be applied to the 3D printing equipment 100 of FIG. 1 and the 3D printing device 130 of FIG. 2. Hereinafter, the detailed steps of the 3D printing method of this embodiment are described with the components in the 3D printing equipment 100 and 3D printing device 130.

First, in step S301, the processor 120 performs the slicing processing on the 3D model to obtain the printing path file and a plurality of inkjet images, wherein the printing path file includes a plurality of layer controlling data corresponding to a plurality of layer objects respectively. The processor 120, according to a slicing thickness anticipated by the user, generates a plurality of slicing planes parallel to each other and performs the slicing processing on the 3D model via the plurality of the slicing planes to obtain the printing path file and the plurality of the inkjet images. Each of the layer controlling data in the printing path file respectively corresponds to a different layer object so that the controller 133 may control the 3D printing device 130 according to each of the layer controlling data to establish each of the layer objects layer by layer. In this embodiment, the printing path file is a file format readable by the controller 133. The controller 133 may, according to the printing path file, control the movement path and position of the printing head 131a and the inkjet head 132a. In addition, when the processor 120 performs the slicing processing on the colored 3D model, the inkjet images corresponding to all or a part of the layer objects will be generated.

In step S302, the controller 133 reads a first layer controlling data in the layer controlling data, wherein the first layer controlling data records a plurality of printing position points and a plurality of inkjet position points. The printing path file is G-code, for example, including control code segments respectively corresponding to different layer objects and the control code segments are called layer controlling data. The first layer controlling data corresponding to a first layer object among the plurality of layer controlling data include coordinates of the plurality of the printing position points and the plurality of the inkjet position points. Then, in step S303, the controller 133, according to the printing position points, controls the movement of the printing head 131a to extrude the forming material 20a to establish the first layer object in the layer objects.

Then, in step S304, the controller 133 reads a first inkjet image among the inkjet images. Further, according to an instruction in the first layer controlling data of the first layer object, the controller 133 reads the first inkjet image corresponding to the first layer object. In step S305, the controller 133, according to the inkjet position points, controls the movement of the inkjet head 132a on the XY plane and controls the inkjet head 132a according to the first inkjet image to spray the ink I1 on the first layer object. However, although only the single first layer object is served as an example to the above, people of ordinary skill in the art of the exemplary examples may deduce the operations of the above steps S302 to S305 to each layer object.

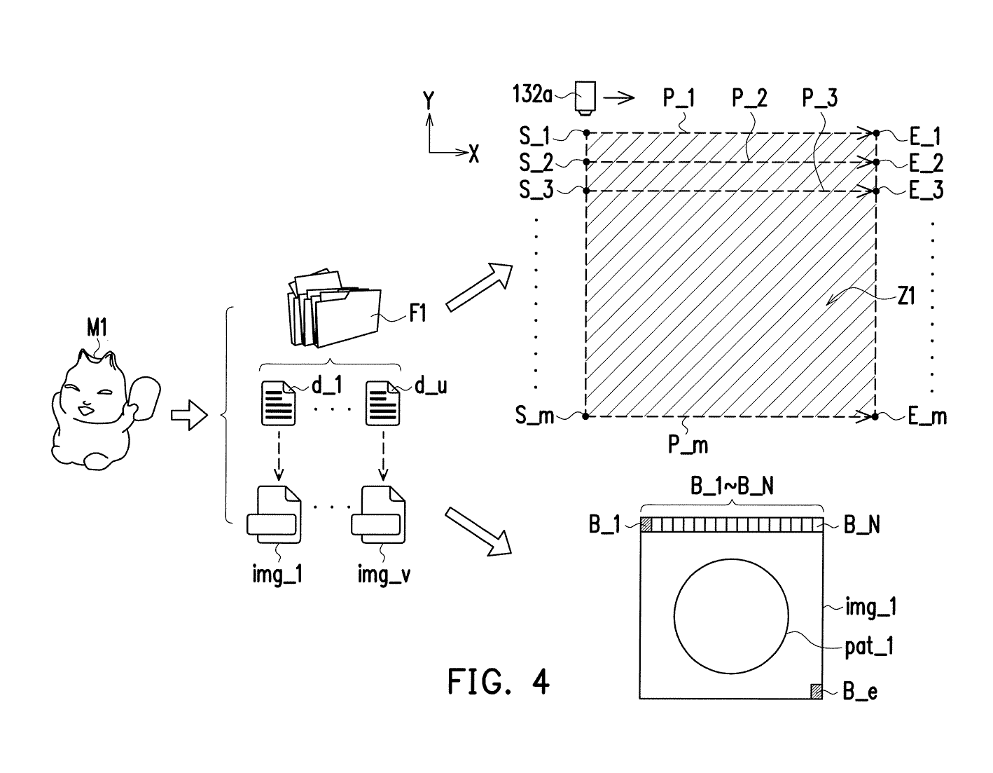

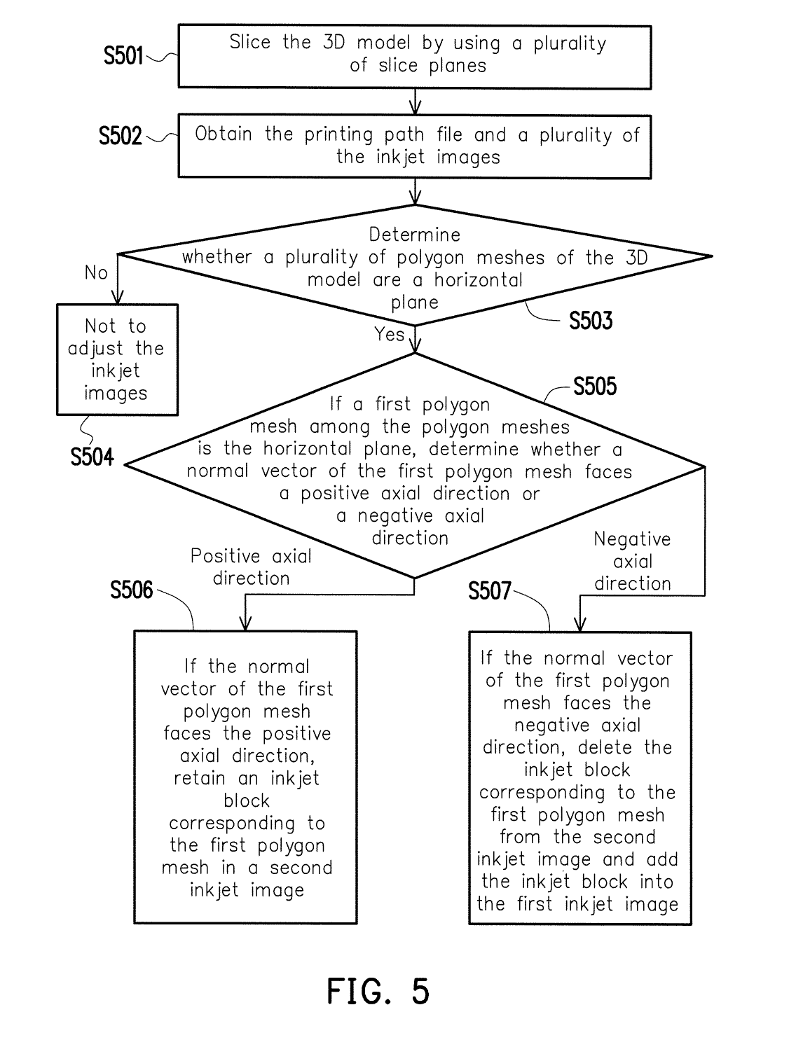

To state the exemplary examples in detail, FIG. 4 is a schematic view of a color 3D printing method according to an embodiment of the disclosure. Referring to FIG. 4, a 3D model M1 is performed the slicing processing to generate a printing path file F1 and v inkjet images img_1 to img_v, wherein v is a positive integer. The printing path file F1 includes u layer controlling data d_1 to d_u, wherein u is a positive integer. The inkjet images img_1 to img_v respectively relate to one of the different layer controlling data d_1 to d_u. For example, the inkjet image img_1 relates to the layer controlling data d_1, and the inkjet image img_v relates to the layer controlling data d_u. It should be stated that each of the layer controlling data d_1 to d_u includes inkjet head positioning information and printing head positioning information. The inkjet head positioning information includes a plurality of the inkjet position points to control the movement of the inkjet head 132a. The printing head positioning information includes a plurality of the printing position points to control the movement of the printing head 131a.

FIG. 4 takes the first inkjet image img_1 and the first layer controlling data d_1 as example. After printing a layer object according to the printing position points in the layer controlling data d_1, the controller 133 reads the coordinates of the inkjet position points in first layer controlling data d_1. The inkjet position points recorded in the first layer controlling data d_1 include m inkjet starting points S_1, S_2, S_3, . . . , S_m and m inkjet end points E_1, E_2, E_3, . . . , E_m. The inkjet starting points S_1, S_2, S_3, . . . , S_m one to one correspond to the plurality of the inkjet end points E_1, E_2, E_3, . . . , E_m. In addition, the inkjet position points recorded in the first layer controlling data d_1 also include an inkjet range starting point and an inkjet range end point defining a size and a position of an inkjet range Z1. In this example, the inkjet starting point S_1 is the inkjet range starting point, the inkjet end point E_m is the inkjet range end point, and the inkjet starting point and the inkjet end point are diagonal vertices of the inkjet range Z1. The movement path of the inkjet head 132a is determined according to these inkjet starting points S_1, S_2, S_3, . . . , S_m and the inkjet end points E_1, E_2, E_3, . . . , E_m.

Based on the above, the controller 133 may associate the inkjet range starting point (i.e., the inkjet starting point S_1) with a starting point pixel B_1 of the first inkjet image img_1, and associate the inkjet range end point (i.e., the inkjet end point E_m) with an end point pixel B_e of the first inkjet image img_1 so that an inkjet order corresponding to each pixel of the first inkjet image img_1 is determined. In detail, the first inkjet image img_1 is composed of a plurality of pixels. For instance, the first row pixels of the first inkjet image img_1 include n-th pixels B_1 to B_n. Each of the plurality of the pixels B_1 to B_n has corresponding pixel color data. After the controller 133 associates the inkjet range starting point with the starting point pixel B_1 and associates the inkjet end point with the first inkjet end point pixel B_e, an inkjet order of each pixel of the first inkjet image img_1 is determined. Take the first row pixels B_1 to B_n as an example, the pixel color data of the first row pixels B_1 to B_n are sequentially read from left to right and printed accordingly.

Further, the controller 133 may control the inkjet head 132a to move along an inkjet path P_1 between the inkjet starting point S_1 among the inkjet starting points S_1 to S_m and the inkjet end point E_1 among the inkjet end points E_1 to E_m. Meanwhile, the controller 133 controls the inkjet head 132a according to the pixels B_1 to B_n corresponding to the first inkjet path P_1 on the first inkjet image img_1 to spray the ink on the layer object. Then, the controller 133 controls the inkjet head 132a to move from the first inkjet end point E_1 to the inkjet starting point S_2 among the inkjet starting points S_1 to S_m, meanwhile, the inkjet head 132a stops spraying ink. Then, the controller 133 controls the inkjet head 132a to move along a second inkjet path P_2 between the inkjet starting point S_2 and the inkjet end point E_2 among the inkjet end points E_1 to E_m. Meanwhile, the controller 133 controls the inkjet head 132a according to pixels corresponding to the second inkjet path P_2 on the first inkjet image img_1 to spray the ink on the layer object. Repeat the above operations. Finally, the controller 133 controls the inkjet head 132a to move along the second inkjet path P_m between the inkjet starting point S_m and the inkjet end point E_m. In the meanwhile, the controller 133 controls the inkjet head 132a according to the last row pixels corresponding to the second inkjet path P_m on the first inkjet image img_1 to spray the ink on the layer object. Such that, the controller 133 controls the inkjet head 132a to move by row and according the pixel color data of each pixel on the first inkjet image img_1 determines whether to spray the ink and ink color so that an ink layer of an inkjet pattern Pat_1 will be coated on the corresponding layer object.

However, it should be stated that, in the circumstance that a bottom surface (attached to a surface of a stage, such as the stage 134 in FIG. 2) or a suspended bottom surface of the 3D printing model has color appearance, if the printing and inkjet are performed at the actual height in the 3D model, the 3D printing device will spray the ink before printing the layer object, causing that the ink is sprinkled out in the air and stains the layer object below, and the 3D object has color missing. Accordingly, the following embodiment further describes a method for adjusting the inkjet position of the disclosure.

FIG. 5 is a flowchart of adjusting an inkjet position on a horizontal plane according to an embodiment of the disclosure. The method of the embodiment is applicable to the 3D printing equipment 100 of FIG. 1 and the 3D printing device 130 of FIG. 2. Hereinafter, the detailed steps of the 3D printing method of this embodiment are described with the components in the 3D printing equipment 100 and the 3D printing device 130.

In step S501, the processor 120 slices the 3D model by using a plurality of slice planes. In step S502, the processor 120 obtains the printing path file and a plurality of the inkjet images. It should be stated that the inkjet images include the first inkjet image corresponding to the first layer object and the second inkjet image corresponding to the second layer object, and a printing order of the first layer object is later than a printing order of the second layer object. In other words, the first layer object stacks on the second layer object. In step S503, the processor 120 determines whether a plurality of polygon meshes of the 3D model are a horizontal plane. The 3D model is composed of the plurality of polygon meshes, which may be triangular meshes, quadrilateral meshes, other concave geometric polygon meshes, or other convex geometric polygon meshes, and the disclosure is not limited thereto. A polygon mesh includes multiple vertices, multiple edges and a face. In this embodiment, the processor 120 determines whether the faces of the plurality of polygon meshes are horizontal planes. Here, the horizontal plane of this embodiment is parallel to the XY plane.

In an embodiment, the slice planes for slicing processing of the processor 120 includes a first slice plane and a second slice plane adjacent to each other. The processor 120 determines whether a plurality of vertices of a first polygon mesh in the polygon meshes are located in a space between the first slice plane and the second slice plane. For instance, the mathematical expression of the first slice plane is Z=a, and the mathematical expression of the second slice plane is Z=b. The processor 120 determines whether Z-axis coordinates of three vertices of a triangular mesh are between a and b to determine whether the three vertices of the triangular mesh are in the space between the first slice plane and the second slice plane. It should be noted that when all the three vertices of the triangular mesh just fall on the first slice plane or the second slice plane, the three vertices of the triangular mesh are determined to be located in the space between the first slice plane and the second slice plane. In an embodiment, if a layer thickness is h, when the three vertices of the first polygon mesh lie in the space between the first slice plane (the mathematical expression is Z=a −0.5 h) and the second slice plane (the mathematical expression is Z=a+0.5 h), the processor 120 determines that the first polygon mesh belongs to the a-th layer of layer object and is a horizontal plane. Then, if each of the vertices of the first polygon mesh is located in the space between the first slice plane and the second slice plane, the processor 120 determines that the first polygon mesh is a horizontal plane. If the vertices of the first polygon cell are not all located in the space between the first slice plane and the second slice plane, the processor 120 determines that the first polygon mesh is not a horizontal plane.

Then, if the processor 120 determines that the plurality of the polygon meshes are not the horizontal plane (determined as No in step S503), in step S504, a primary inkjet image is not adjusted by the processor 120. In step S505, if the first polygon mesh among the polygon meshes is the horizontal plane, the processor 120 determines that a normal vector of the first polygon mesh faces a positive axial direction or a negative axial direction, and the normal vector of the first polygon mesh is a normal vector of the face, which vector direction is point toward outside of the 3D model. Since the definition of the horizontal plane of this embodiment is the XY plane, the positive axial direction is a positive Z-axis direction and the negative axial direction is a negative Z-axis direction. By determining whether the normal vector of the first polygon mesh faces the positive axial direction or the negative direction, the processor 120 can know that the first polygon mesh being the horizontal plane corresponds to a sealing top surface or a sealing bottom surface of the 3D object. The sealing bottom surface includes a lowest bottom surface and the suspended bottom surface of the 3D object.

In step S506, if the normal vector of the first polygon mesh faces the positive axial direction, the processor 120 retains an inkjet block corresponding to the first polygon mesh in the second inkjet image corresponding to the second layer object. In other words, if the normal vector of the first polygon mesh faces the positive axial direction, it represents that the first polygon mesh corresponds to the sealing top surface of the 3D object. In this sense, the processor 120 does not change the inkjet block corresponding to the first polygon mesh and retains the inkjet block corresponding to the first polygon mesh in the second inkjet image corresponding to the second layer object. In step S507, if the normal vector of the first polygon mesh faces the negative axial direction, the processor 120 deletes the inkjet block corresponding to the first polygon mesh from the second inkjet image and adds an inkjet block in the first inkjet image. In other words, if the normal vector of the first polygon mesh faces the negative axial direction, it represents that the first polygon mesh corresponds to the sealing bottom surface of the 3D object. In this sense, the processor 120 deletes the inkjet block corresponding to the first polygon mesh from the second inkjet image originally corresponding to the second layer object and adds the inkjet block corresponding into the first polygon mesh to the first inkjet image corresponding to the former layer object (namely, the first layer object stacked on the second layer object).

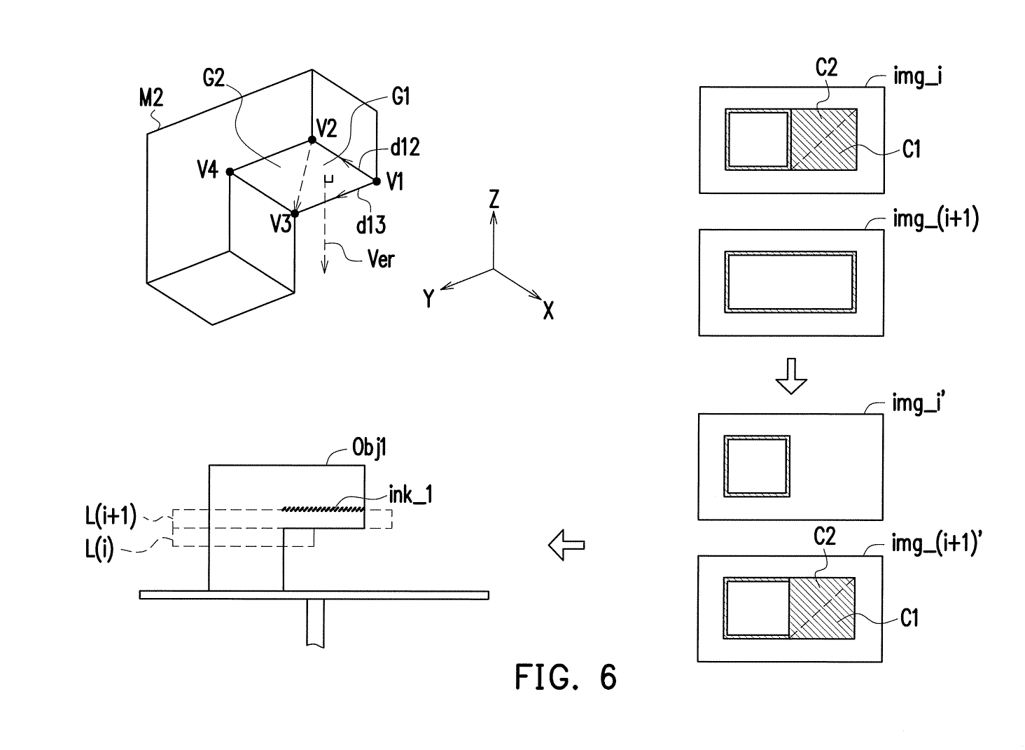

For instance, FIG. 6 is a schematic view of adjusting an inkjet position on a horizontal plane according to an embodiment of the disclosure. Referring to FIG. 6, after performs the slicing processing on a 3D model M2, the processor 120 discovers that three vertices V1, V2 and V3 of a triangular mesh G1 are provided between two adjacent slice planes. Thus, the processor 120 determines that the triangular mesh G1 is the horizontal plane. It should be stated that an order of the vertices V1, V2 and V3 of the triangular mesh G1 is defined in advance according to the inside and outside space of the 3D model. Generally, the normal vector of the face of each triangular mesh of the 3D model faces the eternal space of the 3D model. Accordingly, the processor 120 may obtain a vector d12 and a vector d13 and perform cross product on the vector d12 and a vector d13 to obtain a normal vector Ver. Since the processor 120 determines that the normal vector Ver faces the negative Z-axis direction, the processor 120 adjusts the inkjet position of the inkjet block of the triangular mesh G1. Similarly, the processor 120 may determine according to the similar process that the triangular mesh G2 is a horizontal plane having the normal vector downward and adjust the inkjet position of the inkjet block of the triangular mesh G2 as described above.

As shown in FIG. 6, before the inkjet position of the inkjet block of the horizontal plane is adjusted, a primary inkjet image img_i corresponding to a layer object L(i) of the i-th layer includes an inkjet block C1 corresponding to the triangular mesh G1 and an inkjet block C2 corresponding to the triangular mesh G2. The inkjet block C1 corresponding to the triangular mesh G1 and the inkjet block C2 corresponding to the triangular mesh G2 are not included in the primary inkjet image img_(i+1) corresponding to a layer object L(i+1) of the (i+1)-th layer. After adjusting the inkjet position of the inkjet block of the horizontal plane according to steps S503 to S507 shown in FIG. 5, the inkjet block C1 corresponding to the triangular mesh G1 and the inkjet block C2 corresponding to the triangular mesh G2 are not included in an inkjet image img_i′ corresponding to the layer object L(i) of the i-th layer. The inkjet block C1 corresponding to the triangular mesh G1 and the inkjet block C2 corresponding to the triangular mesh G2 are included in an inkjet image img_(i+1)′ corresponding to the layer object L(i+1) of the (i+1)-th layer. It should be stated that the example shown by FIG. 6 illustrates the case that pixels in the inkjet block C1 and inkjet block C2 completely replace the original pixels located at the corresponding pixel position on the original inkjet image img_(i+11) to generate the inkjet image img_(i+1)′ illustrated by FIG. 6, but the disclosure is not limited thereto. In another embodiment, the pixels in the inkjet block C1 and the inkjet block C2 may partially replace the original pixels located at the corresponding pixel position on the original inkjet image img_(i+1) to retain the partial pixels on the original inkjet image img_(i+1) to generate a new inkjet image.

Such that, during the period in which the 3D printing device 130 establishes a colored 3D object Obj1 according to the 3D model M2, the controller 133 controls the printing head 131a according to the layer controlling data to print the layer object L(i) and further reads the inkjet image img_i′ corresponding to the layer object L(i) among the plurality of the inkjet images. Such that, the controller 133 controls the inkjet head 132a according to the inkjet image img_i′ to spray the ink on the layer object L(i). Briefly, after the printing head 131a prints the layer object L(i), the inkjet head 132a sprays the ink on the layer object L(i) according to the inkjet image img_i′. Then, after the printing head 131a prints the layer object L(i+1) stacked on the layer object L(i), the inkjet head 132a sprays the ink on the layer object L(i+1) according to the inkjet image img_(i+1)′. The inkjet position of the inkjet blocks C1 and C2 will be raised from the lower of the layer object L(i+1) to the upper of the layer object L(i+1). The ink layer ink_1 sprayed by the inkjet head 132a according to each of the pixels of the inkjet blocks C1 and C2 is attached on the layer object L(i+1) instead of sprinkling in the air.

To sum up, the color 3D printing method and 3D printing equipment of the exemplary examples use the printing head to form the layer object on the forming stage and then use the inkjet head to form the ink layer on the layer object to directly dye. Repeatedly, the layer object and the ink layer sequentially stacks across each other so that the colored 3D object is formed. In this sense, the structure of each layer of the colored 3D object has a colored appearance such that the overall color property is improved. Also, different regions of each color ink layer may have different colors to improve color variability. In addition, adjusting the inkjet position of the inkjet block of the horizontal plane may avoid the inkjet head from sprinkling the ink in the air before the sealing bottom surface establishes the layer object for holding the ink to cause level difference between the color property of the 3D object and the 3D model.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. A color three-dimensional printing method for manufacturing a 3D object according to a 3D model, wherein the 3D object comprises a plurality of layer objects, the method comprising:
performing a slicing processing on the 3D model to obtain a printing path file and a plurality of inkjet images, wherein the printing path file comprises a plurality of layer controlling data respectively corresponding to the plurality of the layer objects;
reading a first layer controlling data among the plurality of the layer controlling data, wherein the first layer controlling data records a plurality of printing position points and a plurality of inkjet position points;
controlling movement of a printing head according to the plurality of the printing position points and controlling the printing head to extrude a forming material to establish a first layer object among the plurality of the layer objects;
reading a first inkjet image among the plurality of the inkjet images; and
controlling movement of an inkjet head on a plane according to the plurality of the inkjet position points, and controlling the inkjet head to spray ink on the first layer object according to the first inkjet image.

2. The color three-dimensional printing method according to claim 1, wherein the plurality of the inkjet position points comprise an inkjet range starting point and an inkjet range end point as diagonal vertices of an inkjet range, the method further comprising:
associating the inkjet range starting point among the plurality of the inkjet position points with a starting point pixel of the first inkjet image, and associating the inkjet range end point among the plurality of the inkjet position points with an end point pixel of the first inkjet image, so that an inkjet order corresponding to each pixel of the first inkjet image is determined.

3. The color three-dimensional printing method according to claim 2, wherein the plurality of the inkjet position points comprise a plurality of inkjet starting points and a plurality of inkjet end points, the inkjet starting points correspond one to one to the plurality of the inkjet end points, the inkjet range starting point is one of the plurality of the inkjet starting points and the inkjet range end point is one of the plurality of the inkjet end points.

4. The color three-dimensional printing method according to claim 3, wherein the step of controlling the movement of the inkjet head on the plane according to the plurality of the inkjet position points, and controlling the inkjet head to spray the ink on the first layer object according to the first inkjet image among the plurality of the inkjet images comprises:
controlling the inkjet head to move along a first inkjet path between a first inkjet starting point among the inkjet starting points and a first inkjet end point among the inkjet end points; in the meanwhile, controlling the inkjet head to spray the ink on the first layer object according to pixels corresponding to the first inkjet path of the first inkjet image;
controlling the inkjet head to move from the first inkjet end point to a second inkjet starting point among the inkjet starting points; and
controlling the inkjet head to move along a second inkjet path between the second inkjet starting point and a second inkjet end point among the inkjet end points; in the meanwhile, controlling the inkjet head to spray the ink on the first layer object according to pixels corresponding to the second inkjet path of the first inkjet image.

5. The color three-dimensional printing method according to claim 1, wherein the step of performing the slicing processing on the 3D model to obtain the printing path file and the plurality of the inkjet images comprises:
determining whether a plurality of polygon meshes of the 3D model is a horizontal plane.

6. The color three-dimensional printing method according to claim 5, wherein a step of performing the slicing processing on the 3D model to obtain the printing path file and the plurality of the inkjet images further comprises:
if a first polygon mesh among the plurality of the polygon meshes is the horizontal plane, determining whether a normal vector of the first polygon mesh faces a positive axial direction or a negative axial direction; and
if the normal vector of the first polygon mesh faces the negative axial direction, deleting an inkjet block corresponding to the first polygon mesh corresponding to the first polygon mesh from a second inkjet image, and adding the inkjet block into the first inkjet image, wherein the inkjet head, according to the second inkjet image, sprays the ink on a second layer object stacked below the first layer object.

7. The color three-dimensional printing method according to claim 5, wherein a step of determining whether the plurality of the polygon meshes of the 3D model is the horizontal plane comprises:
using a plurality of slice planes to slice the 3D model, wherein the plurality of the slice planes comprise a first slice plane and a second slice plane adjacent to each other, and the plurality of the slice planes are perpendicular to a positive axial direction and a negative axial direction;
determining whether a plurality of vertices of the first polygon mesh lie in a space between the first slice plane and the second slice plane; and
if each of the plurality of the vertices of the first polygon mesh lies in the space between the first slice plane and the second slice plane, determining that the first polygon mesh is the horizontal plane.

8. The color three-dimensional printing method according to claim 6, wherein the step of performing the slicing processing on the 3D model to obtain the printing path file and the plurality of the inkjet images further comprises:
if the normal vector of the first polygon mesh faces the positive axial direction, retaining the inkjet block corresponding to the first polygon mesh in the second inkjet image.

9. The color three-dimensional printing method according to claim 6, wherein before the step of controlling the movement of the printing head according to the plurality of the printing position points and controlling the printing head to extrude the forming material to establish the first layer object among the plurality of the layer objects, the method further comprises:
controlling the printing head according to a second layer controlling data to print the second layer object among the plurality of the layer objects;
reading the second inkjet image among the plurality of the inkjet images; and
controlling the inkjet head to spray the ink on the second layer object according to the second inkjet image, wherein the first layer object is stacked on the second layer object.

10. A three-dimensional printing equipment for manufacturing a 3D object according to a 3D model, comprising
a storage device;
a processor coupled to the storage device and configured to:
perform a slicing processing on the 3D model to obtain a printing path file and a plurality of inkjet images, wherein the printing path file comprises a plurality of layer controlling data respectively corresponding to a plurality of layer objects; and
a 3D printing device connected to the processor, comprising:
a printing mechanism comprising a printing head;
an inkjet mechanism comprising an inkjet head; and
a controller coupled to the printing mechanism and the inkjet mechanism and configured to:
read a first layer controlling data among the plurality of the layer controlling data, wherein the first layer controlling data records a plurality of printing position points and a plurality of inkjet position points;
control movement of the printing head according to the printing position points and control the printing head to extrude a forming material to establish a first layer object among the plurality of the layer objects;
read a first inkjet image among the plurality of the inkjet images; and
control movement of the inkjet head on a plane according to the plurality of the inkjet position points and control the inkjet head to spray ink on the first layer object according to the first inkjet image.

11. The three-dimensional printing equipment according to claim 10, wherein the plurality of the inkjet position points comprise an inkjet range starting point and an inkjet range end point, and the inkjet range starting point and the inkjet range end point are served as diagonal vertices of an inkjet range,
wherein the controller associates the inkjet range starting point among the plurality of the inkjet position points with a starting point pixel of the first inkjet image, and associates the inkjet range end point among the plurality of the inkjet position points with an end point pixel of the first inkjet image so that an inkjet order corresponding to each pixel of the first inkjet image is determined.

12. The three-dimensional printing equipment according to claim 11, wherein the plurality of the inkjet position points comprise a plurality of inkjet starting points and a plurality of inkjet end points, the plurality of the inkjet starting points correspond one to one to the plurality of the inkjet end points, the inkjet range starting point is one of the plurality of the inkjet starting points and the inkjet range end point is one of the plurality of the inkjet end points.

13. The three-dimensional printing equipment according to claim 12, wherein the controller controls the inkjet head to move along a first inkjet path between a first inkjet starting point among the plurality of the inkjet starting points and a first inkjet end point among the plurality of the inkjet end points, in the meanwhile, controlling the inkjet head to spray the ink on the first layer object according to pixels corresponding to the first inkjet path on the first inkjet image,
wherein the controller controls the inkjet head to move from the first inkjet end point to a second inkjet starting point among the plurality of the inkjet starting points;
wherein the controller controls the inkjet head to move along a second inkjet path between the second inkjet starting point and a second inkjet end point among the plurality of the inkjet end points, in the meanwhile, controlling the inkjet head to spray the ink on the first layer object according to pixels corresponding to the second inkjet path on the first inkjet image.

14. The three-dimensional printing equipment according to claim 10, wherein the processor determines whether a plurality of polygon meshes of the 3D model are a horizontal plane,
if a first polygon mesh among the plurality of the polygon meshes is the horizontal plane, the processor determines whether a normal vector of the first polygon mesh faces a positive axial direction or a negative axial direction; and
if the normal vector of the first polygon mesh faces the negative axial direction, the processor deletes an inkjet block corresponding to the first polygon mesh from a second inkjet image, and adds the inkjet block into the first inkjet image.

15. The three-dimensional printing equipment according to claim 14, wherein the processor uses a plurality of slice planes to slice the 3D model, the plurality of the slice planes comprise a first slice plane and a second slice plane adjacent to each other, and the plurality of the slice planes are perpendicular to the positive axial direction and the negative axial direction,
wherein the processor determines whether a plurality of vertices of the first polygon mesh lie in a space between the first slice plane and the second slice plane, and the processor determines that the first polygon mesh is the horizontal plane if each of the plurality of the vertices of the first polygon mesh lies in the space between the first slice plane and the second slice plane.

16. The three-dimensional printing equipment according to claim 14, wherein the processor retains the inkjet block corresponding to the first polygon mesh in a second inkjet image if the normal vector of the first polygon mesh faces the positive axial direction.

17. The three-dimensional printing equipment according to claim 14, wherein the controller is further configured to: control the printing head according to a second layer controlling data to print a second layer object among the plurality of the layer objects; read a second inkjet image among the plurality of the inkjet images; and control the inkjet head to spray the ink on the second layer object according to the second inkjet image, wherein the first layer object is stacked on the second layer object.

18. A color three-dimensional printing method adapted to a three-dimensional printing equipment, the three-dimensional printing equipment comprising a printing head and an inkjet head and able to manufacture a 3D object according to a 3D model, wherein the 3D object comprises a plurality of layer objects, the method comprising:
performing a slicing processing on the 3D model to obtain a printing path file and a plurality of inkjet images;
controlling movement of the printing head according to the printing path file and controlling the printing head to extrude a forming material to establish a first layer object among the plurality of the layer objects; and
controlling movement of the inkjet head according to the printing path file and controlling the inkjet head to spray ink on the first layer object according to a first inkjet image among the plurality of the inkjet images.

19. The color three-dimensional printing method according to claim 18, wherein the printing path file comprises a plurality of layer controlling data respectively corresponding to the plurality of the layer objects, and each of the layer controlling data comprises a plurality of printing position points for controlling the printing head and a plurality of inkjet position points for controlling the inkjet head.

20. The color three-dimensional printing method according to claim 18, wherein the 3D model comprises a plurality of polygon meshes for defining the 3D object, and wherein the step of performing the slicing processing on the 3D model to obtain the printing path file and the plurality of inkjet images comprises:
determining whether the plurality of the polygon meshes are a horizontal plane.

21. The color three-dimensional printing method according to claim 20, further comprising: if a first polygon mesh among the plurality of the polygon meshes is the horizontal plane, determining whether the first polygon mesh is a sealing bottom surface.

22. The color three-dimensional printing method according to claim 21, wherein the step of determining whether the first polygon mesh is the sealing bottom surface comprises: determining according to a normal vector of the first polygon mesh cell.

23. The color three-dimensional printing method according to claim 21, further comprising: if the first polygon mesh is the sealing bottom surface, deleting an inkjet block corresponding to the first polygon mesh from a second inkjet image corresponding to the first polygon mesh after the slicing processing, and adding the inkjet block into the first inkjet image, wherein the inkjet head sprays ink on a second layer object according to the second inkjet image, and the second layer object is stacked below the first layer object.
